(19) United States
(12) Patent Application Publication
(10) Pub. No.: US 2020/0362271 A1
(43) Pub. Date: Nov. 19, 2020

(54) BACTERIAL PREPARATION, A METHOD FOR PREPARING A CLEANING SOLUTION, A CLEANING SOLUTION, AND A METHOD FOR CLEANING DIRTY TARGETS

(71) Applicant: Green Berry Oy, Espoo (FI)

(72) Inventors: Mikko Haapsaari, Espoo (FI); Timo Kaarlela, Nummela (FI); Esko Aulanko, Kerava (FI); Olli-Pekka Kaleva, Hyvinkää (FI)

(73) Assignee: Green Berry Oy, Espoo (FI)

(21) Appl. No.: 16/763,949

(22) PCT Filed: Nov. 13, 2018
(86) PCT No.: PCT/FI2018/050833

§ 371 Date: May 13, 2020

(30) Foreign Application Priority Data
Nov. 13, 2017 (FI) 20176015
Apr. 10, 2018 (FI) 20185343

(51) Int. Cl. C11D 3/38; C11D 3/48; C11D 3/04; A01N 63/22; A01N 25/26; A01N 25/02

(52) U.S. Cl. CPC C11D 3/381; C11D 3/48; A01N 25/02; A01N 63/22; A01N 25/26; C11D 3/046

(57) ABSTRACT

The invention concerns a bacterial preparation, a method for preparing a cleaning solution, a cleaning solution and a method for cleaning targets, which contain impurities. The cleaning solution contains at least bacterial preparations, such as portion capsules, with bacteria which are harmless to humans and animals, such as probiotics, mixed into a liquid, such as water. The used water is preferably tapwater, from which components that kill bacteria in said bacterial preparations have been removed and preferably also all or nearly all salts.

### FIELD OF THE INVENTION

The invention concerns a bacterial preparation, as well as a method for preparing a cleaning solution, a cleaning solution and a method for cleaning targets containing impurities.

### BACKGROUND OF THE INVENTION

The solution according to the invention concerns non-toxic cleaning and purification. Commonly used detergents and cleaning agents, later cleaning agents, are composed of many different components and cause a burden on the environment throughout the entire product life cycle.

Components of cleaning agents are typically oil-based, which is not a renewable natural resource. Therefore, the use of known cleaning agent and their disposal release emissions into water, air and soil. In addition, the active agents contained in the chemicals of some cleaning agents are toxic, and they can accumulate in organisms and be enriched in the food chain. The chemicals also contain components, which cause eutrophication in water systems.

Cleaning agents containing chemicals also have health effects on humans. Humans can come in contact with cleaning agent chemicals through the mouth and skin as well as through the respiratory tract or indirectly through the environment. In addition, humans can come into contact with cleaning agent chemicals through food. Since all cleaning agent chemicals are not broken down in the waste water treatment process, chemicals are accumulated in the waters, in the ground waters and further in drinking water as well as in human nutrition, such as in fish. The problem with chemicals is also that their use causes development of even more resistant microbe strains.

One of the components in known cleaning agents, especially in disinfecting cleaning agents, is chloride compounds. The problem with such cleaning agents is that they are corrosive to the skin and irritating to do eyes, and they can even damage the eyes. They can also emit gases, which if inhaled can cause allergies or asthma symptoms and breathing difficulties. Further, cleaning agents containing chloride compounds are bad for the environment.

Various allergies as well as sensitivity to fragrances and chemicals have the increased and also the awareness of these has increased. This is one reason why the cleaning business has started searching for ways to reduce the use of chemicals in cleaning agents. Therefore, as one of the known solutions for providing chemical free cleaning, ozonized water has been used as cleaning agent. Ozone is a very reactive and strong oxidizer so it is therefore effective for killing microbes. However, for the same reason the problem with ozone is that it is also very bad for the health and it can damage all sorts of organic surfaces.

Ozone reacts very easily with almost any compound, which it comes to contact with. Therefore, if it is for example inhaled, it reacts very strongly with fats, proteins and the like in cells, which damages or kills the cells.

If inhaled, ozone paralyzes the lunch function and harms the lung tissue, and causes cough and difficulty in breathing. Other symptoms which are related to high concentrations of ozone are irritation and redness of the eyes, irritation of the nose and throat, fatigue, nausea and headache. Also allergy symptoms can get worse due to high concentrations of ozone. Especially sensitive to irritation symptoms due to ozone are asthmatics and small children.

According to studies as much as 3% of people in Europe die due to influence of ozone either indirectly or through traffic emissions and the ozone concentration caused by these. When cleaning with ozonized water the dose that the cleaners or the surfaces to be cleaned is subjected to is hundreds of times stronger than what is caused by traffic. However, the harmful effects of ozonized water have been diminished and the reasons for this are for example due to the short time of exposure by one cleaning occasion. The exposure is shorter for the people in the spaces to be cleaned, however, for the persons performing the cleaning are easily exposed up to eight hours a day. According to studies also very short time exposure to high ozone concentrations can cause severe health problems. One problem with deaths and diseases caused by ozone is that the diseases are lung diseases and it is impossible to indicate their origin. Hence, these diseases and deaths are not noted as being caused by ozone.

Yet another problem with cleaning using ozonized water is that the ozone concentration decreases very quickly, so already after one cleaning occasion the cleaning capability of ozonized water is reduced so much that removing dirt starts requiring more mechanical cleaning. This means for example starting to scrub the surfaces to be cleaned with a more strongly. Using more strength, however, will cause burden for the person performing the cleaning.

Due to the before mentioned problems and drawbacks even more harmless and non-toxic cleaning agents have been developed. One promising line of development has been to use bacteria, which is harmless to humans and animals as active agents in cleaning agents. In most of these cases, probiotics have been used as active agents in the cleaning agents. The use of probiotics has started from hospitals and the hospital bacteria problems. The problem has been the ability of the bacteria to develop resistance to disinfectants. One effective solution for this has been probiotics, which replace other kinds of bacteria and change the bacterial strains of the facilities to healthier kinds. Thus, probiotics have not originally been developed as active agents for cleaning agents, but instead they have been developed for solving the resistance problems caused by disinfection agents. For conventional liquid probiotic concentrates the essential feature has not been that non-toxicity, but instead the fact that they contain probiotics. In probiotic concentrates, biocides are needed in order to stabilize the bacterial spores. The aim is that they should not develop into bacteria from the spores in the concentrate. They are usually less toxic and thus less harmful than conventional cleaning agents, but they are not in any way non-toxic, because usually also surfactants, i.e. surface active agents, are added to them some of which are toxic.

In these prior art solutions, the active agents containing bacteria stored as spores are packed as liquid concentrates in special containers or cans, such as vials and ampules. Liquid concentrates containing bacterial spores and packed in this way are called for example probiotic concentrates.

The problem with known probiotics concentrates is their dosing. The dosing is a big challenge in the cleaning industry, because the risk is that the concentrates are dosed too much. In addition, one challenge is to ensure the activity of the probiotic bacteria, i.e. changing the bacterial spores in to viable bacteria in the cleaning solution manufactured from the probiotics concentration. The problem with the cleaning solution manufactured from the probiotics concentration is that the bacterial spores do not develop into reproducing bacteria instead they remain as spores. Then again in the probiotics concentrate itself one problem is the stabilization of the bacterial spores, so that they will not awaken in the concentrate and the spores will turn into bacteria.

When using the cleaning agent, the probiotics concentrate is dosed into water to prepare the cleaning agent solution to be used. Usually, there are no requirements set for the quality of the water to be used, so the water that is used, for example ordinary tap-water, may contain compounds that kill microbes such as chloride or ozone. In this case the bacteria from the probiotic concentrate or at least a part of them will die in the prepared cleaning agent solution rather fast, due to this when using the cleaning solution the cleaning result will not be as desired. Therefore, the expected advantage from the bacteria, i.e. bringing living bacterial cells to the surface to replace other sorts of bacteria, may not be successful.

One problem is also that the probiotic spores in the probiotics concentration turn into reproducible and functioning bacteria in the prepared cleaning agent solution only after they receive the proper nutrition. With probiotic spores in this application is meant spores of probiotic bacteria. In tap-water there usually are not enough of these nutrients, so the function is obtained only after the cleaning solution has been spread onto the surface to be cleaned and then also only if the surface contains appropriate nutrition. Therefore, using probiotic concentrates according to the prior art solutions does not enable preparing specific and even-quality cleaning solutions. Furthermore, the liquid probiotic concentrations have a very limited shelf life, so they cannot be stored for long amounts of time.

This sets certain requirements on the logistics for handling these preparations. One problem is also that the spores have a tendency to remain on the bottom of the container, so the concentration needs to be shaken before use and in this case the risk is that the bacterial spore amount necessary is not obtained from a spray bottle. The transportation of liquid probiotic concentrates also burdens the environment, they take up a lot of space and it is not ergonomic to use them, they can freeze and they create plastic waste.

Another problem associated with the use of prior art probiotic cleaning agents is that the bacterial spores in the probiotic concentration have been stabilized using various toxics, usually biocides. In addition, tensides are used, which are strong toxics and in this way they destroyed the whole idea of non-toxic cleaning, i.e. the nontoxicity itself.

### SUMMARY OF THE INVENTION

The object of the invention is to solve the before mentioned problems and to provide an economical and simple bacterial preparation, and a method for preparing an essentially non-toxic cleaning solution. In addition, the aim of the invention is to provide an economical, chemical free and closest to non-toxic cleaning solution, which has a good cleaning efficiency and which does not cause harm to the health or the environment. Further, the aim is to provide a cleaning solution, in which bacteria which is harmless to humans and animals are used as active agent. The aim of the invention is also to provide a method for cleaning dirty surfaces, which does not harm the health, is safe for the environment and easy to use.

Thus, the present invention concerns a bacterial preparation for preparing a cleaning solution, which bacterial preparation contains spores of bacteria, which is harmless to humans and animals, and bacterial nutrients. The bacterial preparation according to the invention is characterized by what has been presented in the characterizing part of claim 1.

The method according to the invention for preparing a cleaning solution is characterized by what has been presenter in the characterizing part of claim 7. Correspondingly, the cleaning solution according to the invention is characterized by what has been presented in the characterizing part of claim 12. In addition, the method according to the invention for cleaning targets containing impurities is characterized by what has been presented in the characterizing part of claim 19. The other embodiments of the invention are characterized by what has been presented in the other claims.

To carry out the purpose of the invention, to prepare a cleaning solution containing bacteria, which are harmless to humans and animals, in the method according to the invention bacterial preparations are mixed with water. Preferably, said bacterial preparations are mixed with water as bacterial preparation, such as a portion capsule, containing bacterial spores and bacterial nutrients.

The invention is based on the discovery that if the bacterial spores are packed in a compact form together with suitable nutrients, the bacterial spores are quickly transformed in the prepared cleaning solution into functioning and reproductive bacteria. Thus, the bacterial preparation according to the invention, the methods and the cleaning solution obtained therewith, have many advantages. The idea of the invention is that a majority of harmless bacteria is brought to the surfaces to be cleaned, which replaces possible harmful bacteria i.e. pathogenic bacteria. With the solutions according to the invention also the cleaning result will improve, because the bacteria are functional and produce enzymes into the cleaning solution. The enzymes will improve the cleaning result even more. In the prior art solutions, the advantage brought by the enzymes has not been utilized, because the function and reproducibility of the bacteria has not been on the same level, instead the bacteria have primarily been in spore-form. In the solution according to the invention bacteria are added to the surface to be cleaned, which bacteria are capable of functioning in a way which is characteristic to the bacteria immediately, because they are already functional. This way, bacterial spores will not be wasted, and instead their entire capacity can be utilized.

Preferably, the cleaning solution according to the invention will contain at least bacterial compounds, which are harmless to humans and animals mixed with a liquid, which bacterial compounds comprise bacterial spores that are packed in bacterial preparation, such as portion capsules, together with bacterial nutrients. Preferably, said liquid is water, from which components that kill bacteria in said bacterial preparations and essentially also all salts, and in addition to the salt also possible other minerals, especially those containing calcium and magnesium, have been removed. Preferably, the bacterial nutrients are packed in a bacterial preparation, such as a portion capsule, together with bacterial spores, and also the portion capsule shell is arranged to function as nutrient for said bacteria.

The water may be any kind of suitable water or raw-water, which is suitable for the selected cleaning method. Preferably, the used water is tap-water, which has been purified and/or which has been made into demineralized water using one or several of the following treatments: active carbon treatment, chemicals, reverse osmosis, ion exchange, UV disinfection, oxidizing organic compounds.

The advantage of the solutions according to the invention is that the cleaning solution is a chemical free solution. Thus, the cleaning solution used according to the invention does not cause allergy symptoms or health problems for humans. In addition, the cleaning solution is environmentally friendly. When using demineralized water from which essentially all salts have been removed as liquid in the cleaning solution, no mineral stains will remain on the cleaned surfaces after drying. In addition to this, it is essential that the demineralized water will remove and bind impurities better, so the cleaning result obtained using it is better than with tap-water. One advantage is also that due to the non-toxicity of the cleaning solution according to the invention, the use of the cleaning solution does not promote bacterial strains to develop more resistant. The solutions according to the invention enable residue free cleaning.

When the used bacterial spores are in closed bacterial preparations, such as in portion capsules, as freeze dried, a further advantage is that the shelf life of the bacterial spores is excellent, which also makes logistics easier. The advantages of the preparations according to the invention are for example that they take up significantly less space than liquid concentrates, they are lighter, and they do not freeze. One further advantage is that since the portion capsules and the shell of the portion capsules contain nutrition for the bacterial spores, they will quickly develop into efficiently reproducing bacteria already when contacting the water for the solution, while the cleaning solution is prepared. Thus, the cleaning solution distributed onto the target to be cleaned will take effect quickly and efficiently. Yet another advantage is that the bacterial preparations, such as portion capsules, do not require a lot of space.

### SHORT DESCRIPTION OF THE FIGURES

FIG. 1 illustrates how fast the bacteria germinate and transform into functional in different solutions, which contain mixtures of different nutrients.

### DEFINITIONS

In this application the following terms and expressions have the following meanings:

“Bacterial preparation” is a combination that comprises at least bacterial spores that are harmless to humans and animals and bacterial nutrients. Preferably, the bacterial preparation is solid, such as a portion capsule, a pressed piece, a powder, a granule or a tablet, especially a portion capsule. The bacterial preparation may be selected from the group consisting of a portion capsule, a pressed piece, a concentration, a powder, a granule, a liquid concentration, a gel, an ampule, a spray or a tablet. In addition, the mixture may comprise other necessary additives and fillers, which are non-toxic. The contents of the bacterial preparation can dissolve in water to form a cleaning solution.

“Bacteria” or “bacterial spores” are bacteria, which are harmless to humans and animals. They are preferably food quality approved probiotics. For example, the bacteria, which are harmless to humans and animals, may be selected from the strains of the Bacillus genus. More specifically, the spores are for example selected from the group consisting of the following Bacillus subtilis, Bacillus subtilis var. amyloliguefaciens, Bacillus pumilus, Bacillus licheniformis and Bacillus megaterium, whereby the bacterial preparation comprises one strain or a mixture of several strains.

### DETAILED DESCRIPTION OF THE INVENTION

The use of bacteria that is harmless to humans and animals, such as probiotics, in cleaning is known as such. The focus, when using probiotics has not been the cleaning result, but instead the prevention of harmful bacteria.

Probiotics can also efficiently remove dirt and fat from the surfaces to be cleaned. The efficiency of the probiotics is based on the fact that contrary to traditional cleaning, where the aim is to kill harmful microbes from the surfaces to be cleaned with toxics, in probiotic cleaning microbes, which are harmless to humans and animals, are spread onto the surfaces—in this case for example probiotic bacteria—whereby the bacteria take over living space from harmful microbes. After some time the harmful microbes have disappeared or their strains have been reduced remarkably. The present invention is based on that the bacteria also take part in improving the cleaning result. The use of biocides may be substituted. By using probiotics, biocides may be replaced in every day cleaning.

Tests show that harmful bacteria, i.e. pathogenic bacteria, will be significantly reduced or completely vanished on the surfaces to be cleaned.

The solutions according to the invention, such as the bacterial preparation and the cleaning solution manufactured therefrom, bring significant advantages compared to the prior art solutions.

In addition, the aim of the invention is to provide as non-toxic cleaning as possible. According to one embodiment, the bacterial preparations and methods according to the invention provide a completely non-toxic cleaning.

The cleaning result is traditionally described as the sum of four different factors: time, temperature, chemistry and mechanics. The cleaning method according to the invention simplifies the cleaning, because in the method the chemistry step (i.e. the chemicals) can be left out.

The solutions according to the invention, especially the method, are particularly suited for surfaces, which humans and animals are in contact with directly. For these, the complete non-toxicity and replacing the harmful bacteria with harmless bacteria are great advantages.

The cleaning solution according to the invention is a chemical free solution, which in its simplest form comprises only demineralized water, in which bacteria that is harmless to humans and animals has been mixed, such as for example probiotics. By demineralized water herein and later is meant water, from which at least components that kill the bacteria, which is harmless to humans and animals, has been removed. Preferably, also essentially all salts have been removed from the before mentioned water. In addition, minerals, such as calcium and magnesium, and other components that affect the hardness have been removed from the water.

Preferably, the water to be used is tap-water. It may also be other raw-water. Since tap-water usually contains chloride or chloride containing compounds as a component, such water should be purified, for example demineralized, before bacterial spores, such as probiotic spores, are mixed into it. Otherwise the chloride will kill the bacteria or at least reduce their functionality. A majority of the microbes are killed already at rather low chloride concentrations. In different parts of the world, different chloride compounds are used and in varying amounts, whereby also the need to remove chloride will vary.

Another important reason to purify water, apart from removing the negative effects of chloride, is removing salts and minerals, whereby the cleaning ability of the water will improve. It will be transformed into so called “hungry water”, which more effectively binds dirt. The cleaning properties will also improve, since no residues will be left on the surfaces. The components that increase water hardness are removed, which improves the cleaning result. With the same methods also heavy metals will be removed from the water, which will further enhance the non-toxic cleaning.

Preferably, the components that kill the bacteria, which is harmless to humans and animals, such as probiotics, is removed from the water used for the cleaning solution using active carbon, chemicals and/or reverse osmosis. In addition, essentially all or nearly all salts are removed from the water used for the cleaning solution using reverse osmosis and/or ion exchange. Preferably, the water is purified using reverse osmosis before preparing the cleaning solution. The water to be used for the cleaning solution of the invention, contains salts and/or salt minerals and/or other impurities below 50 ppm, preferably 20 ppm, more preferably 10 ppm, and most preferably below 5 ppm, when preparing the cleaning solution.

The bacteria, which is harmless to humans and animals, used in the cleaning solution of the invention is a packed as a bacterial preparation, such as in portion capsules, together with bacterial nutrients for said bacteria. As nutrient for example lactose is preferably used. In a preferred embodiment, the bacterial preparation of the invention comprises also sugar as a nutrient. Preferably, the sugar comprises at least one sugar, which is selected from the group consisting of: fructose, lactose and glucose. In a preferred embodiment, the bacterial preparation comprises amino acid, preferably the amino acid comprises at least one amino acid, which is selected from the group consisting of: L-alanine, L-glycine, L-valine and L-asparagine, as well as optionally salt, additives and/or fillers. The bacterial preparation may also contain other nutrients, such as tryptone.

According to one embodiment, the bacterial preparation according to the invention is solid. A solid preparation is preferred, because the bacterial spores may be freezedried, whereby their shelf life is very good. Further, a solid bacterial preparation has the advantage that its preservability may be ensured without biocides.

The bacterial preparation is preferably a portion capsule. In addition, the shell of the portion capsule in that case may function as nutrition for said bacteria. The shell is preferably gelatin. The bacteria is inside the portion capsule as spores, preferably freeze-dried spores, which can withstand even extreme conditions for a long time and do not need biocides to be preserved. Freeze-drying is preferred also, because the bacteria will be preserved without stabilizing agents. Further, the portion capsules may contain various additives. Preferably, the portion capsules contain as additive an agent, which makes the cleaning result of the cleaning solution more effective. One of these substances is for example sodium carbonate, i.e. soda. According to one embodiment, the bacterial preparation of the invention comprises soda.

Freeze-drying is a preferred method for preparing the bacterial preparations, because thus they will remain stable without toxics. Good stability of the bacteria is a very important feature for the bacterial preparation of the invention, because it can guarantee a long shelf life. For example, if the bacteria are mixed with a liquid, the risk is that they will not remain stable and awaken in their own time, in other words they will not be preserved. Another alternative could be to preserve the bacterial spores in salt. An object of the solution according to the invention was to provide non-toxic stabilization of the bacteria. Freeze-drying enables this. According to a preferred embodiment, the freeze-drying is performed in a temperature, which is at least −20° C., such as between −20° C. and −196° C., or for example between −20° C. and −90° C.

According to one embodiment, the bacterial preparation in addition contains enzymes. With enzymes the cleaning result can be further improved. Enzymes may be selected according to the type of impurity. For example, the removal of blood and fat stains may be enhanced by adding appropriate enzymes to the bacterial preparation. Enzymes are preferably enzymes that are harmless to humans and animals. Also combinations of different enzymes are possible. In one preferred embodiment, the bacterial preparation also contains salt. Salt can speed up germination of the bacteria. The salt is preferably for example sodium chloride and/or potassium chloride.

According to one embodiment, the bacterial preparation of the invention is a preparation that contains bacterial spores and bacterial nutrients, which preparations is selected from the group consisting of a portion capsule, a pressed piece, a concentration, a powder, a granulate, a liquid concentration, a gel, an ampule, a spray and a tablet, preferably a portion capsule.

According to one embodiment, the bacterial preparation of the invention does not contain fat, fatty acids and/or triglycerides.

According to one embodiment, the bacterial preparation is in the form of a portion capsule and consists of bacterial spores, and bacterial nutrients, wherein said nutrients comprise sugar, preferably the sugar comprises at least one sugar from the group consisting of the following fructose, lactose and glucose, and an amino acid, preferably the amino acid comprises at least one amino acid, which is selected from the group consisting of the following L-alanine, L-glycine, L-valine and L-asparagine, and optionally salt, additives, fillers and/or enzymes.

The cleaning solution according to the invention contains purified water, in which a desired amount of bacterial preparation has been dissolved, such as the portion capsules mention above. The shell of the portion capsule or the like dissolves into the water and the bacterial spores inside the portion capsules as well as the nutrients, and possibly also fillers, will get into contact with the water during the dissolving phase. Thereby, the bacterial spores will develop into active, reproducing through dividing, bacteria and when receiving a lot of the nutrition from inside the capsules and dissolved from the shell, the bacteria will reproduce quickly, which makes the cleaning solution effective. Fully functional bacteria can use dirt as their nutrition, whereby they will remove stains more efficiently than spores. The speed of the process, wherein the bacterial spores will develop into bacteria, depends on the nutrients. The speed may be for example at least 0.5 h, or at least 1 h, at least 2 h or at least 3 h. Preferably, the cleaning solution is kept for 1 h-16 h before cleaning. It is essential that the bacterial preparation, such as a portion capsule, has time to at least dissolve in the liquid before using the cleaning solution and this usually happens within 0.5 h. The speed of the process can be varied by changing the temperature of the liquid. The temperature of the liquid is preferably at least 20° C. To obtain a faster process, the temperature of the liquid is preferably 30° C. or about 30° C. A too high temperature may, however, damage the bacterial spores and bacteria.

According to one embodiment, the bacterial preparation contains at least 50 million, such as 50 million-1 billion, preferably 100-500 million, CFUs i.e. colony-forming units. The amount could also be 80-800 million CFUs, or 30 150-450 million CFUs. In addition to this, the bacterial preparation contains as nutrients totally about 0.1 g-2 g, or 0.2 g-1.2 g, preferably 0.5-1 g, 1 g capsule.

The size of the preparation, such as a portion capsule, is preferably 0.5 g-5 g, or even 10 g, preferably 1 g-2 g. The weight is the total weight, which includes also optional additives and fillers. The appropriate weight depends on the form and purpose of the bacterial preparation.

The necessary amount of bacterial preparation per liter of cleaning liquid is for example the following;

The bacterial preparation is in form of a portion capsule, whereby 1 capsule per 500 ml liquid is added. On capsule contains 100-500 million CFU i.e. colony-forming units. In addition, one capsule contains 0.5 g-1 g nutrients.

The total amount of the bacterial preparation may be for example 1 g/500 ml-5 g/500 ml. The amount depends on the efficiency of the nutrients.

One example of the composition of the bacterial preparation:

0 size capsule (i.e. a 500 mg capsule) may contain the following amount of nutrients:

Glucose: 5.6 mmol/l

Glycine: 10 mmol/l

Potassium chloride: 10 mmol/l

Bacterial spores: 100 million CFU (i.e. colony forming-units)

According to the method of the invention, said cleaning solution is prepared by mixing bacterial preparations containing bacteria that is harmless to humans and animals with water as a bacterial preparation containing bacterial spores and bacterial nutrients, such as portion capsules, which are dissolved in water so that the nutrients in the portion capsule and the nutrients of the shell of the potion capsule will be available to the bacterial spores as the bacterial spores develop from bacterial spores to reproductive bacteria.

According to the invention, the above mentioned bacterial preparations, which for example contain spores of probiotics, preferably one strain or a mixture of several strains of the Bacillus genus, are mixed into water from which the components that kill the bacteria of said bacterial preparations and essentially also all salts have been removed. It is especially preferred that tap-water is used as water, which has been made into demineralized water using one or more of the following steps: active carbon treatment, chemicals, reverse osmosis, ion exchange, UV disinfection, oxidizing organic compounds.

The cleaning solution mixed in a before mentioned manner, can be used for days or even for several weeks. The preparation may thus be prepared for example one day beforehand. However, it is preferred that the cleaning solution is prepared by mixing the bacterial preparation in demineralized, essentially room temperature tap-water just before or closely before using the cleaning solution. Preferably, the mixing is conducted at least 1 h, or a few hours before the use of the cleaning solution. The time may be for example 1 h-20 h or 2 h-16 h. According to one embodiment, the cleaning solution is prepared at least 12 h before its use. Thereby, it is ensured that the majority i.e. at least 50% of the bacterial spores have transformed from bacterial spores into germinated or vegetative bacteria. It is essential, that at least part of the bacterial spores have time to transform into vegetative bacteria in the solution before cleaning. This enables achieving improved cleaning result. Correspondingly, with the method according to the invention for cleaning targets containing impurities, the area/spot/target to be cleaned is brought into contact with the cleaning solution, which solution contains at least bacterial spores that are harmless to humans and animals and their nutrients mixed into water, from which the components that kill the bacteria in said bacterial preparations have been removed. Said bacterial spores are for example probiotic spores, preferably one strain or several strains of the Bacillus genus. For example, Bacillus subtilis, Bacillus subtilis var. amyloliquefaciens, Bacillus pumilus, Bacillus licheniformis or Bacillus megaterium. According to one embodiment, the bacterial preparation comprises a strain of Bacillus subtilis. This is a preferred choice, since the strain has been extensively studied and has been shown to be harmless. In addition, it is well suited for the solution according to the invention, because it efficiently replaces harmful bacteria on the surfaces to be cleaned.

Preferably, the area/spot/target to be cleaned is brought into contact with a cleaning solution, which solution contains at least bacterial spores that are harmless to humans and animals and their nutrients mixed with water, from which the components that kill the bacteria of said bacterial preparations and/or essentially all salts have been removed using one or more of the following: active carbon treatment, chemicals, reverse osmosis, ion exchange, UV disinfection, oxidizing organic compounds, or that the area/spot/target to be cleaned is brought into contact with a cleaning solution, which solution contains at least spores of bacteria that are harmless to humans and animals and their nutrients mixed in demineralized water. Preferably, the water to be used is demineralized tap-water. The water may also be other suitable water, such as spring water, which fulfils the set requirements. As raw-water to be purified also for example sea water or lake water could be used, which is suitable for a water purification method.

Different surfaces of various sizes as well as objects and even textiles can be purified with the cleaning solution and method according to the invention. The cleaning method according to the invention preferably includes a mechanical cleaning step, wherein a piece of cleaning equipment is used in combination with the cleaning solution according to the invention. This way the most effective cleaning result is obtained.

Preferably, the method for cleaning targets containing impurities comprises a mechanical cleaning step, wherein the area/spot/target to be cleaned is treated with cleaning equipment.

In practice, the cleaning of smaller surfaces is carried out for example in the following way: 1) a cleaning solution according to the invention is mixed in a spray bottle, which comprises bacterial preparation that is harmless to humans and animals, such as probiotics and demineralized water i.e. water, from which the components that kill the bacteria of said bacterial preparations and essentially all salts have been removed; 2) the cleaning solution is sprayed from the bottle onto the surfaces to be cleaned; 3) the surfaces which have been sprayed are wiped with a clean cleaning cloth, preferably a micro fiber cloth.

Similarly, the cleaning of larger surfaces, for example floors, is carried out in the following way: 1) demineralized water and bacterial preparations that are harmless to humans and animals, such as probiotics, are mixed into a cleaning solution in a water container, such as a basin, bucket or pail; 2) a piece of cleaning equipment, such as a mop or the like is moistened in the cleaning solution in the water container; 3) the surfaces to be cleaned are wiped with damp/wet cleaning equipment.

An alternative way is also:
1) Mixing the cleaning solution in a dosing bottle.
2) The dosing bottle is used to damp/wet the cleaning equipment (such as a mop or a cleaning cloth) in the bucket/container.
3) The surfaces to be cleaned are wiped with damp/wet cleaning equipment.

Larger surfaces may preferably also be cleaned using combined machines for cleaning, which usually have their own container for clean water and a cleaning brush or another corresponding surface cleaning member. In connection with the cleaning, the cleaning solution according to the invention is prepared by mixing a desired amount of portion capsules comprising bacterial preparations that are harmless to humans and animals in demineralized water in the clean water container, until a desired mixture ration is obtained. The combined machine may also have automatic portioning machine, whereby the preparation of the cleaning solution is done automatically.

After cleaning the dirty targets, the cleaning equipment that has been in contact with the bacterial preparations that are harmless to humans and animals, such as probiotics, such as cleaning cloths, mops, cleaning brushes or similar equipment, are washed with water from which the components that kill bacterial preparations that are harmless to humans and animals, such as probiotics, have been removed. Preferably, said cleaning equipment is washed with tap-water that has been demineralized using active carbon treatment and/or reverse osmosis.

The temperature of the cleaning water is for example about +60 . . . +95° C., preferably about +80 . . . +90° C. The before mentioned cleaning equipment is for example washed in a washing machine. Washing powder is usually not used, but if washing powder is used, so called black soap or another similar natural soap may be used. Demineralized water, from which the components that cause water hardness have been removed, does not form precipitation with natural soap. Natural soap is non-toxic and thus beneficial, since a completely non-toxic process may be ensured even to the washing of the cleaning equipment.

Also all other cleaning equipment used in the cleaning according to the invention, apart from the before mention cleaning equipment, that has been directly in contact with the target to be cleaned, may be cleaned after the cleaning with the before mentioned demineralized water.

It is clear to the person skilled in the art that the different embodiments of the invention are not limited to specifically the before mentioned examples, but may vary within the limits of the claims presented below. It is essential for the solutions, that a chemical free cleaning solution may be prepared and used, wherein bacterial compositions, such as probiotics which are known as such, which are harmless to humans and animals, are mixed as bacterial preparations, such as portion capsules, into as bacterial friendly water as possible whereby the effect of the cleaning solution is clearly better than if the bacterial preparations were to be mixed into any kind of water as in the prior art solutions. Furthermore, it is essential that said bacterial preparations that are harmless to humans and animals are preserved as bacterial spores, for example in portion capsules, together with the nutrients needed by the bacteria and/or also the shell of the portion capsules are nutrition which is suitable for the bacteria.

More detailed examples of the embodiments:

1. A method for preparing a cleaning solution containing bacteria, which is harmless to humans and animals, in which method bacterial preparations are mixed with water, characterized in that when preparing the cleaning solution, said bacterial preparations are mixed in liquid as portion capsules containing bacterial spores and bacterial nutrients.

2. The method according to example 1, characterized in that said bacterial preparations, which contain for spores of probiotics packed into portion capsules, preferably one strain or a mixture of several strains of the bacillus genus, are mixed with water, preferably tap-water, from which the components that kill bacteria of said bacterial preparations have been removed.

3. The method according to example 1 or 2, characterized in that the components that kill bacteria of the bacterial preparations and/or essentially all salts are removed from the water using active carbon, chemicals and/or reverse osmosis, after which said bacterial preparations are mixed in the purified water.

4. The method according to any one of the preceding examples, characterized in that the water used when preparing the cleaning solution is turned into demineralized water using one or several of the following steps: active carbon treatment, chemicals, reverse osmosis, ion exchange, UV disinfection, oxidizing organic compounds.

5. A cleaning solution, which contains at least bacterial preparations, which are harmless to humans and animals, mixed with liquid, characterized in that said bacterial preparations comprise bacterial spores, which are packed into bacterial preparations, preferably portion capsules, together with bacterial nutrients and that the liquid is water from which components that kill bacteria in said bacterial preparations have been removed.

6. The cleaning solution according to example 5, characterized in that said bacterial nutrients are packed in bacterial preparations, preferably portion capsules, together with bacterial spores.

7. The cleaning solution according to example 5 or 6, characterized in that the bacterial preparation is a portion capsule and the shell of the portion capsule is arranged to function as nutrition for said bacteria.

8. The cleaning solution according to example 5, 6 or 7, characterized in that inside the bacterial preparations, preferably in a portion capsule, also agents which enhance the cleaning result have been added and/or other fillers.

9. The cleaning solution according to any one of the examples 5 to 8, characterized in that the liquid, from which the components that kill bacteria of said bacterial preparations, is tap-water.

10. The cleaning solution according to any one of the examples 5 to 9, characterized in that said components that kill bacteria in said bacterial preparations are removed from the liquid using active carbon, chemicals and/or reverse osmosis, and that from the liquid also essentially all salts have been removed, preferably either using reverse osmosis and/or ion exchange.

11. The cleaning solution according to any one of the examples 5 to 10, characterized in that the bacterial spores of said bacterial preparations are probiotic spores, preferably one stain or a mixture of several strains of the Bacillus genus.

12. A method for cleaning targets containing impurities using a cleaning solution containing bacterial preparations, which are harmless to humans and animals, in which method the area/spot/target to be cleaned is brought into contact with bacterial preparations which are harmless to humans and animals, characterized in that the area/spot/target to be cleaned is brought into contact with a cleaning solution, which contains at least bacterial spores, which are harmless to humans and animals, and their nutrients mixed in a liquid, from which constituents which kill the bacteria in said bacterial preparations have been removed.

13. The method according to example 12, characterized in that the area/spot/target to be cleaned is brought into contact with a cleaning solution, which solution contains at least bacterial spores, which are harmless to humans and animals, and their nutrients mixed in water, from which components that kill the bacteria in said bacterial preparations, and that said bacterial spores are probiotic spores, preferably one strain or a mixture of several strains of the Bacillus genus.

14. The method according to example 12 or 13, characterized in that the area/spot/target to be cleaned is brought into contact with the cleaning solution, which solution contains at least bacterial spores, which are harmless to humans and animals, and their nutrients mixed with water, from which said components that kill bacteria of said bacterial preparations and/or salts, have been removed using one or more of the following steps: active carbon treatment, chemicals, reverse osmosis, ion exchange, UV disinfection, oxidizing organic compounds, or that the area/spot/target to be cleaned is brought into contact with a cleaning solution, which solution contains at least bacterial spores, which are harmless to humans and animals, and their nutrients mixed with demineralized water.

15. The method according to any one of the examples 12 to 14, characterized in that after cleaning the targets containing impurities, the cleaning equipment which have been in contact with said bacterial preparations are washed with water, from which the components that kill bacteria of said bacterial preparations have been removed, at a temperature of essentially +60 . . . +95° C., preferably +80 . . . +90° C.

16. The method according to example 15, characterized in that after cleaning the targets containing impurities, the cleaning equipment which have been in contact with the bacteria of the bacterial preparations are cleaned with water, which has been demineralized using active carbon treatment and/or reverse osmosis.

### EXAMPLE 1

It is important for the method and/or the cleaning solution of the invention that the bacteria have time to germinate or to develop into vegetative before the cleaning step. Tests were performed whereby the percentage of the bacteria present in the solution was measured: spore/germinated/vegetative bacteria. In the tests water was used, which had been purified using reverse osmosis.

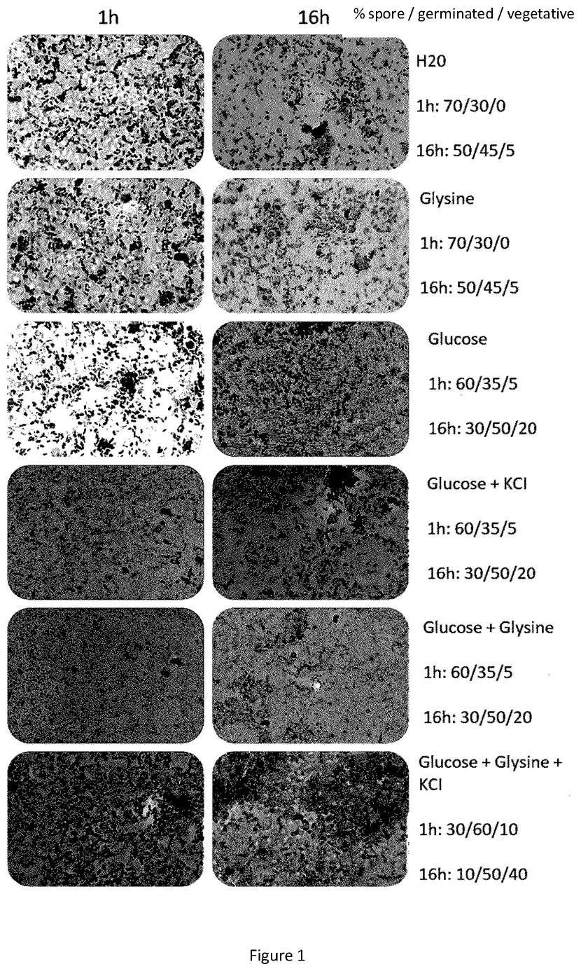

The performed measurements and their results can be seen in Table 1. FIG. 1 also shows the results of the measurements.

| | | Ratio % | Ratio % |
|---|---|---|---|
| | | Spore/germinated/ | Spore/germinated/ |
| Test | Solution | vegetative 1 h | vegetative 16 h |
| 1 | H₂O | 70/30/0 | 50/45/5 |
| 2 | H₂O + glycine | 70/30/0 | 50/45/5 |
| 3 | H₂O + glucose | 60/35/5 | 30/50/20 |
| 4 | H₂O + glucose + | 60/35/5 | 30/50/20 |
| | KCl | | |
| 5 | H₂O + glucose + | 60/35/5 | 30/50/20 |
| | glysine | | |
| 6 | H₂O + glucose + | 30/60/10 | 10/50/40 |
| | glysine + KCl | | |

Test 1 is a reference example. In tests 2-6 the bacterial preparation of the invention is used, which comprises bacterial spores as well as bacterial nutrients.

The results show that the fastest bacterial “awakening”, i.e. germination as well as turning into vegetative happens, when the bacterial preparation of the invention is used. The overall most efficient mixture was number 6, in which sugar (glucose), amino acid (glycine) as well as salt (KCl) were combined.

1. A bacterial preparation for preparing a cleaning solution, characterized in that the bacterial preparation contains spores of bacteria that are harmless to humans and animals, as well as bacterial nutrients.

2. The bacterial preparation according to claim 1, characterized in that the bacterial preparation is a preparation containing bacterial spores and bacterial nutrients selected from the group consisting of the following a dosage capsule, a pressed piece, a concentrate, a powder, a granulate, a liquid concentrate, a gel, an ampule, a spray and a tablet, preferably a dosage capsule.

3. The bacterial preparation according to claim 1, characterized in that said nutrients comprise
a. sugar, preferably the sugar comprises at least one sugar selected from the group consisting of fructose, lactose and glucose, and
b. amino acid, preferably the amino acid comprises at least one amino acid selected from the group consisting of L-alanine, L-glycine, L-valine ja L-asparagine, and
c. optionally, an additive, a filler, enzymes and/or salt.

4. The bacterial preparation according to claim 1, characterized in that the bacterial preparation comprises salt, preferably sodium chloride (NaCl) or potassium chloride (KCl).

5. The bacterial preparation according to claim 1, characterized in that said spores of bacteria that are harmless to humans and animals are selected from strains of the Bacillus genus, preferably the spores are selected from the group consisting of the following Bacillus subtilis, Bacillus subtilis var. amyloliquefaciens, Bacillus pumilus, Bacillus licheniformis, and Bacillus megaterium, wherein the bacterial preparation comprises one strain or a mixture of several strains, preferably Bacillus subtilis.

6. The bacterial preparation according to claim 1, characterized in that the bacterial preparation comprises freeze-dried bacterial spores.

7. A method for preparing a cleaning solution containing bacteria, which is harmless to humans and animals, in which method bacterial preparations are mixed with water, characterized in that when preparing the cleaning solution, said bacterial preparations are mixed in liquid as a bacterial preparation containing bacterial spores and bacterial nutrients, preferably as a portion capsule containing these.

8. The method according to claim 7, characterized in that after said mixing when preparing said cleaning solution, the mixture is kept for at least 0.5 h, preferably at least 1 h, more preferably 1 h-16 h before using the cleaning solution.

9. The method according to claim 7, characterized in that said bacterial preparations, which contain for example spores of probiotics packed into portion capsules, preferably one strain or a mixture of several strains of the Bacillus genus, are mixed with water, preferably tap-water, from which the components that kill bacteria of said bacterial preparations have been removed.

10. The method according to claim 7, characterized in that the components that kill bacteria and/or essentially all salts are removed from the water using active carbon, chemicals and/or reverse osmosis, after which said bacterial preparations are mixed in purified water.

11. The method according to claim 7, characterized in that the water used when preparing the cleaning solution is turned into demineralized water using one or several of the following steps: active carbon treatment, chemicals, reverse osmosis, ion exchange, UV disinfection, oxidizing organic compounds.

12. A cleaning solution, which contains at least bacterial preparations, which are harmless to humans and animals, mixed with liquid, characterized in that said bacterial preparations comprise bacterial spores, which are packed into bacterial preparations, preferably portion capsules, together with bacterial nutrients and that the liquid is water from which components that kill bacteria in said bacterial preparations have been removed.

13. The cleaning solution according to claim 12, characterized in that said bacterial nutrients are packed in bacterial preparations, preferably portion capsules, together with bacterial spores.

14. The cleaning solution according to claim 12, characterized in that the bacterial preparation is a portion capsule and the shell of the portion capsule is arranged to function as nutrition for said bacteria.

15. The cleaning solution according to claim 12, characterized in that inside the bacterial preparations, preferably in a portion capsule, also agents which enhance the cleaning result have been added and/or other fillers.

16. The cleaning solution according to claim 12, characterized in that the liquid, from which the components that kill bacteria of said bacterial preparations, is tap-water, which contains salts, minerals or other impurities below 50 ppm, preferably below 20 ppm and most preferably below 5 ppm, before mixing with the bacterial preparation.

17. The cleaning solution according to claim 12, characterized in that said components that kill bacteria in said bacterial preparations are removed from the liquid using active carbon, chemicals and/or reverse osmosis, and that from the liquid also essentially all salts are removed, preferably either using reverse osmosis and/or ion exchange.

18. The cleaning solution according to claim 12, characterized in that the bacterial spores of said bacterial preparations are probiotic spores, preferably one stain or several strains of the Bacillus genus.

19. A method for cleaning targets containing impurities using a cleaning solution containing bacterial preparations, which are harmless to humans and animals, in which method the area/spot/target to be cleaned is brought into contact with bacterial preparations that are harmless to humans and animals, characterized in that the area/spot/target to be cleaned is brought into contact with a cleaning solution, which contains at least bacterial spores, which are harmless to humans and animals, and their nutrients mixed in a liquid, from which constituents which kill the bacteria in said bacterial preparations have been removed.

20. The method according to claims 19, characterized in that the area/spot/target to be cleaned is brought into contact with a cleaning solution, which solution contains at least bacterial spores, which are harmless to humans and animals and their nutrients mixed in water, from which components that kill the bacteria in said bacterial preparations, and that said bacterial spores are probiotic spores, preferably one strain or a mixture of several strains of the Bacillus genus.

21. The method according to claim 19, characterized in that the area/spot/target to be cleaned is brought into contact with a cleaning solution, which solution contains at least bacterial spores, which are harmless to humans and animals, and their nutrients mixed with water, from which said components that kill bacteria of said bacterial preparations and/or salts, have been removed using one or more of the following steps: active carbon treatment, chemicals, reverse osmosis, ion exchange, UV disinfection, oxidizing organic compounds, or that the area/spot/target to be cleaned is brought into contact with a cleaning solution, which solution contains at least bacterial spores, which are harmless to humans and animals, and their nutrients mixed with demineralized water.

22. The method according to claim 19, characterized in that when preparing the cleaning solution, after said mixing, the formed mixture is kept for at least 0.5 h, preferably at least 1 h, more preferably 1 h-16h before using the cleaning solution.

23. The method according to claim 19, characterized in that after cleaning the targets containing impurities, the cleaning equipment which have been in contact with said bacterial preparations are washed with water, from which the components that kill bacteria of said bacterial preparations have been removed, at a temperature of essentially +60 . . . +95° C., preferably +80 . . . +90° C.

24. The method according to claim 23, characterized in that after cleaning the targets containing impurities, the cleaning equipment which have been in contact with the bacteria of the bacterial preparations are cleaned with water, which has been demineralized using active carbon treatment and/or reverse osmosis.

25. The method according to claim 19, characterized in that the method comprises a mechanical cleaning step, wherein the area/spot/target to be cleaned is processed using cleaning equipment.
